(19) United States
(12) Patent Application Publication
(10) Pub. No.: US 2026/0120908 A1
(43) Pub. Date: Apr. 30, 2026

(54) Electrode Assembly and Radioisotope Battery Comprising the Same

(71) Applicant: LG Energy Solution, Ltd., Seoul (KR)

(72) Inventors: Dong Myung Kim, Seoul (KR); Je Young Kim, Daejeon (KR); Dong Myung Shin, Daejeon (KR)

(73) Assignee: LG Energy Solution, Ltd., Seoul (KR)

(21) Appl. No.: 19/371,610

(22) Filed: Oct. 28, 2025

(30) Foreign Application Priority Data
Oct. 28, 2024 (KR) 10-2024-0148743
Oct. 27, 2025 (KR) 10-2025-0157159

(51) Int. Cl. G21H 1/06; H01M 4/36; H01M 10/04; H01M 50/107; H01M 50/152; H01M 50/474

(52) U.S. Cl. CPC G21H 1/06; H01M 4/36; H01M 10/0431; H01M 50/107; H01M 50/152; H01M 50/474

(57) ABSTRACT

A jelly roll type electrode assembly includes a first electrode, a second electrode, an energy conversion layer positioned between the first electrode and the second electrode, and a radioactive source positioned either between the first electrode and the energy conversion layer or between the second electrode and the energy conversion layer. The layers of the electrode assembly are stacked and collectively wound around a central axis to define a jelly roll configuration. The electrode assembly may include an insulating layer positioned along a surface of at least one of the first electrode and the second electrode that faces away from the radioactive source. The radioactive source may include a radioisotope that emits alpha or beta particle radiation, and the energy conversion layer may include semiconductor materials defining a P-N junction for absorbing such radiation. A radioisotope battery including the electrode assembly may also be provided.

### CROSS-REFERENCE TO RELATED APPLICATIONS

This application claims priority to Korean Patent Application No. 10-2024-0148743, filed on Oct. 28, 2024, and Korean Patent Application No. 10-2025-0157159, filed on Oct. 27, 2025, the disclosures of which are incorporated herein by reference in their entirety.

### BACKGROUND

### 1. Field of the Invention

Example aspects of the present disclosure relate to an electrode assembly and a radioisotope battery comprising the same.

### 2. Description of the Related Art

A radioactive isotope or “radioisotope” is an element that decays into a stable isotope while emitting radiation. Alpha decay, beta decay, and gamma decay have been known as the ways in which a radioisotope decays. That is, depending on the type of radioisotope, the radioisotope emits alpha rays, beta rays, or gamma rays while it decays. The time it takes for the amount of radioactivity to decrease to half of its initial amount as a radioisotope decays is called a half-life period. The type of radiation emitted by the decay and the half-life period are determined by the specific type of radioisotope.

In general, a radioisotope battery is a battery that uses nuclear decay energy in the form of radiation emitted from a decaying radioisotope and converts it into electrical energy to use the electrical energy as an electrical power source. Specifically, the radiation is absorbed by a P-N junction semiconductor, thereby forming electron-hole pairs in the depletion region and enabling use of an electric power source through the generated electrons and holes.

### SUMMARY

An aspect provides an electrode assembly that can be applied to electronic products requiring high power by producing high-density power, as well as a radioisotope battery including such electrode assembly, and a battery pack comprising such radioisotope battery.

According to an aspect, there is provided an electrode assembly including a first electrode, a second electrode, an energy conversion layer positioned between the first electrode and the second electrode, and a radioactive source positioned either between the first electrode and the energy conversion layer or between the second electrode and the energy conversion layer. The first electrode, the second electrode, the energy conversion layer, and the radioactive source of the electrode assembly are arranged in layers on one another and collectively wound in one direction around a central axis to define a jelly roll configuration.

The electrode assembly may include an insulating layer positioned along an outer surface of at least one of the first and second electrodes that faces away from the radioactive source.

The insulating layer may include a first insulating layer and a second insulating layer, where the first insulating layer may be positioned along the outer surface of the first electrode, and the second insulating layer may be positioned along the outer surface of the second electrode.

The radioactive source may include a first radioactive source and a second radioactive source, where the first radioactive source is positioned between the first electrode and the energy conversion layer, and the second radioactive source is positioned between the second electrode and the energy conversion layer.

The radioactive source may be positioned along an inner surface of either the first electrode or the second electrode that faces towards the energy conversion layer.

The radioactive source may be positioned along the inner surface such that a decreasing amount of the radioactive source is located at increasing distances along the inner surface from the central axis.

The inner surface of either of the first or second electrode may include at least one groove defined within it, where the radioactive source is positioned within such groove.

The inner surface of the electrode may include a plurality of such grooves spaced apart from each other so that at least a portion of the inner surface without any grooves is located between at least two adjacent grooves.

The radioactive source may include a radioisotope that emits alpha and/or beta particles.

The electrode assembly may further include a third electrode that is positioned between the energy conversion layer and the radioactive source.

The energy conversion layer may include a first energy conversion layer and a second energy conversion layer. The first energy conversion layer may include a first type of semiconductor material adjacent to the first electrode, and the second energy conversion layer may include a second type of semiconductor material adjacent to the second electrode.

One of the first and second types of semiconductor materials may be a P-type semiconductor and the other may be an N-type semiconductor, such that a P-N junction is defined at an interface between the P-type and N-type semiconductors.

The first electrode may be in contact with at least a portion of the first energy conversion layer, and the second electrode may be in contact with at least a portion of the second energy conversion layer.

The radioactive source may be in contact with the first energy conversion layer at an interface having an undulating profile.

The first electrode and the second electrode may further include a first electrode tab and a second electrode tab, respectively, on at least a portion of an outer surface of the respective first and second electrode that faces away from the energy conversion layer.

The electrode assembly may further include a central member oriented along the central axis.

The electrode assembly may further include a protective layer positioned along an outer surface of at least one of the first electrode and the second electrode that faces away from the radioactive source.

The energy conversion layer may include a seed layer or a catalyst particle layer.

According to another aspect, a radioisotope battery includes the electrode assembly; a housing accommodating the electrode assembly therein; and a cap assembly positioned to cover an open upper portion of the housing.

According to still another aspect, a battery pack includes the radioisotope battery.

According to exemplary aspects of the present disclosure, it is possible to provide an electrode assembly that can be applied to electronic products requiring high power by producing high-density power. Other aspects of the present disclosure provide a radioisotope battery including such electrode assembly. Furthermore, aspects of the present disclosure provide a battery pack comprising such radioisotope battery and/or a power device.

### BRIEF DESCRIPTION OF THE FIGURES

The drawings provided in the present disclosure are based on example aspects of the present disclosure, and the ratios of the width, length, or thickness (or height) of components are provided for a detailed description of the present disclosure and may differ from the actual dimensions, i.e., the drawings are not necessarily to scale. In addition, the axes in coordinate systems illustrated in the drawings may be perpendicular to each other, and a direction pointed to by an arrow may be a positive (+) direction along a particular dimension, and a direction opposite to the direction pointed to by the arrow (i.e., the direction rotated by) 180° may be a negative (−) direction along that dimension.

FIG. 1 is a perspective, partially exploded view illustrating at least a portion of an electrode assembly according to an example aspect of the present disclosure.

FIG. 2 is a perspective, partially exploded view illustrating at least a portion of the electrode assembly according to another example aspect of the present disclosure.

FIG. 3 is a perspective, partially exploded view illustrating at least a portion of the electrode assembly according to another example aspect of the present disclosure.

FIG. 4 is a cross-sectional view illustrating at least a portion of a first electrode according to an example aspect of the present disclosure.

FIG. 5 is a cross-sectional view illustrating at least a portion of a second electrode according to an example aspect of the present disclosure.

FIG. 6 is a cross-sectional view illustrating at least a portion of the first electrode according to another example aspect of the present disclosure.

FIG. 7 is a cross-sectional view illustrating at least a portion of the second electrode according to another example aspect of the present disclosure.

FIG. 8 is a plan view illustrating at least a portion of the first electrode according to an example aspect of the present disclosure.

FIG. 9 is a plan view illustrating at least a portion of the first electrode according to another example aspect of the present disclosure.

FIG. 10 is a plan view illustrating at least a portion of the first electrode according to another example aspect of the present disclosure.

FIG. 11 is a plan view illustrating at least a portion of the first electrode according to another example aspect of the present disclosure.

FIG. 12 is a plan view illustrating at least a portion of the first electrode according to another example aspect of the present disclosure.

FIG. 13 is a perspective, partially exploded view illustrating at least a portion of the electrode assembly according to another example aspect of the present disclosure.

FIG. 14 is a perspective, partially exploded view illustrating at least a portion of the electrode assembly according to an example aspect of the present disclosure.

FIG. 15 is a perspective, partially exploded view illustrating at least a portion of the electrode assembly according to another example aspect of the present disclosure.

FIG. 16 is a perspective view illustrating at least a portion of the electrode assembly rolled up according to an example aspect of the present disclosure.

FIG. 17 is a perspective view illustrating at least a portion of the electrode assembly rolled up according to another example aspect of the present disclosure.

FIG. 18 is a perspective view illustrating at least a portion of a radioisotope battery according to an example aspect of the present disclosure.

FIG. 19 is a perspective partially transparent and partially exploded schematic illustrating at least a portion of the radioisotope battery according to an example aspect of the present disclosure.

FIGS. 20A to 20E are cross-sectional views illustrating interface shapes of a first energy conversion layer and a second energy conversion layer according to various possible aspects of the present disclosure.

FIG. 21 is a cross-sectional view illustrating at least a portion of the electrode assembly according to an aspect of the present disclosure.

FIG. 22 is a cross-sectional view illustrating at least a portion of the electrode assembly according to another aspect of the present disclosure.

FIG. 23 is a cross-sectional view illustrating at least a portion of the electrode assembly according to another aspect of the present disclosure.

FIG. 24 is a perspective view illustrating at least a portion of the electrode assembly according to another aspect of the present disclosure.

### DETAILED DESCRIPTION

Before describing the present disclosure, it is noted that the terms and terminology used herein and in the claims is not to be construed based on common meanings or meanings found in dictionaries. Rather, the inventor(s) may appropriately define the concepts of terms used, and thus such terms should be interpreted in a manner consistent with the technical ideas of the present disclosure. Further, the example aspects of the disclosure described in this specification and the structures illustrated in the drawings are merely preferred example implementations of the present disclosure and may not represent the entire scope of the technical idea of the present disclosure. Accordingly, as of the filing date of the present disclosure, various equivalents and modifications may exist, which are also considered to be encompassed by the present disclosure.

The same reference numbers or symbols used in each drawing and the specification may indicate parts or components that perform substantially the same function. For the convenience of description and understanding, the same reference numbers or symbols may be used in different example aspects. In other words, even if components having the same reference numbers are illustrated in multiple drawings, it does not necessarily mean that such multiple drawings represent a single aspect.

In the following description, singular forms are intended to include plural forms unless the context clearly indicates otherwise. It will be further understood that the terms “comprise,” “constitute,” “include,” and “have,” as used in this specification, specify the presence of stated features, steps, operations, components, parts, or a combination thereof, but do not preclude the presence or addition of one or more other features, numerals, steps, operations, components, parts, or a combination thereof.

In addition, in the following description, terms such as upper side, upper portion, lower side, lower portion, side, front, and rear are based on the directions illustrated in the drawings, but the illustrated components are not limited to being oriented in the same manner as illustrated. Thus, such directional terms may be expressed differently if the direction of the subject component changes.

In addition, in the specification and the claims, terms including ordinal numbers such as “first” and “second” may be used to distinguish between components. These ordinal numbers may be used to distinguish the same or similar components from each other, and the meaning of the terms should not be restrictively construed by the use of these ordinal numbers. As an example, components combined with these ordinal numbers should not be limited in order of use or arrangement by the ordinal numbers. If necessary, the ordinal numbers may be interchanged with one another.

In this specification, a battery may be a term that collectively refers to a unit, such as a battery cell, or a battery module or a battery pack including multiple battery cells.

Hereinafter, example aspects of the present disclosure are described in detail with reference to the accompanying drawings. However, the spirit of the present disclosure may not be limited to the illustrated and discussed examples. For example, those skilled in the art who understand the spirit of the present disclosure may envision other examples that fall within the scope of the present disclosure by adding, modifying, or removing components, and such other examples shall also be considered to fall within the scope of the present disclosure. The shapes and sizes of the components in the drawings may be exaggerated for more clear explanation.

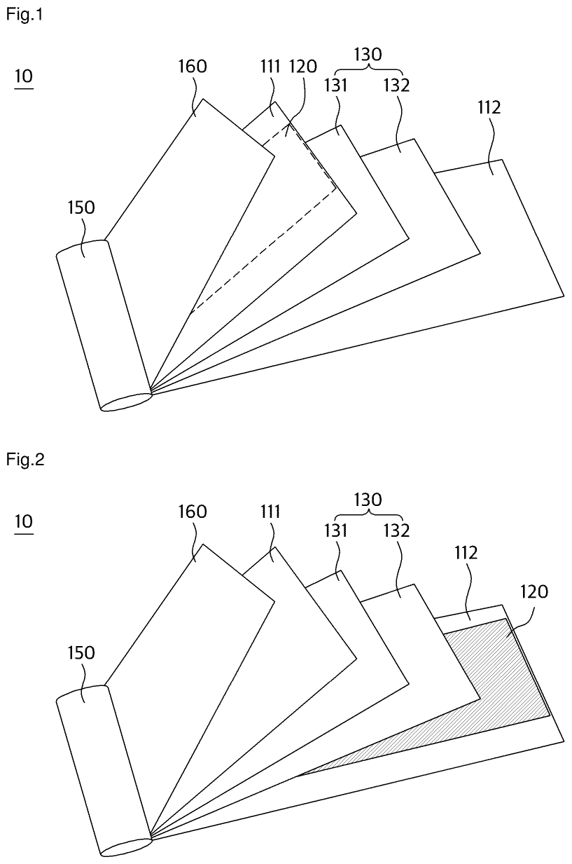

FIG. 1 is a perspective, partially exploded view illustrating an electrode assembly 10 according to an example aspect of the present disclosure.

In one example, the electrode assembly 10 is a jelly roll type electrode assembly comprising stacked arrangement of a first electrode 111, a second electrode 112, an energy conversion layer 130 provided between the first electrode 111 and the second electrode 112, and at least one radioactive source layer 120 provided in a respective at least one of: (1) a space between the first electrode 111 and the energy conversion layer 130, and (2) a space between the second electrode 112 and the energy conversion layer 130. In the specific example illustrated in FIG. 1, the radioactive source layer 120 is provided in a space between the first electrode 111 and the energy conversion layer. The first electrode 111, the second electrode 112, the energy conversion layer 130, and the radioactive source(s) 120 are laminated (i.e., stacked on one another) and wound in one direction around a central member (arranged along a central axis) to form electrode assembly 10. The electrode assembly 10 may include at least one insulating layer 160 on a surface of a respective at least one of the first electrode 111 and the second electrode 112 that faces away from the radioactive source 120. Such surfaces of the first and second electrodes that face away from the radioactive source 120 may be referred to as outer surfaces of the respective electrodes.

By having the radioactive source stacked between the electrode and the energy conversion layer, in contrast to the radioactive source being arranged on an opposite, outer side of the electrode from the energy conversion layer, the radiation emitted from the radioactive source beneficially travels a relatively shorter distance to the energy conversion layer. As a result, the amount of radioisotope transferred to the energy conversion layer per unit time may be greater, resulting in excellent efficiency. Furthermore, by having the electrode arranged radially outside the radioactive source in the rolled up state of the jelly roll, the electrode may also beneficially have the function of shielding or blocking much of the radiation from being emitted outside of the battery, which may make the battery safer.

In one example, as illustrated in FIG. 1, the electrode assembly 10 may be a jelly roll type electrode assembly wound around the central member 150 in one direction into a rolled up state.

One of the first electrode 111 and the second electrode 112 may include an anode that provides electrons, while the other is a cathode that receives electrons.

In one example, the second electrode 112 may be an opposite electrode of the first electrode 111. That is, when the first electrode 111 is an anode, the second electrode 112 may be a cathode. Conversely, when the first electrode 111 is a cathode, the second electrode 112 may be an anode.

In one example, the first electrode 111 and the second electrode 112 may include a current collector. The first electrode 111 and the second electrode 112 are not specifically limited in terms of type, size, and shape, as long as they have electrical conductivity without causing physical or chemical changes to the radioisotope battery. For example, the first electrode 111 and the second electrode 112 may independently include metallic materials such as gold (Au), silver (Ag), platinum (Pt), stainless steel, copper (Cu), aluminum (Al), nickel (Ni), or titanium (Ti), including transparent oxides such as fluorine (F)-doped tin oxide (FTO), zinc oxide (ZnO), or indium tin oxide (ITO, In₂₋ₓSnₓO₃, in which 0<x<2), or including carbon-based compounds such as carbon-nanotubes, graphene, reduced graphene, and graphene oxide.

The first electrode 111 and the second electrode 112 may be identical to each other or different from each other.

The electrode assembly 10 according to an example aspect of the present disclosure may include the energy conversion layer 130 between the first electrode 111 and the second electrode 112.

In one example, the energy conversion layer 130 may form electron-hole pairs by being impacted by the radiation emitted from the radioactive source 120. In one example, the energy conversion layer 130 may be an inorganic layer, an organic layer, a dye sensitized layer, or a combination thereof, and may generate electrical energy by forming electron-hole pairs using the radiation.

Examples of the inorganic layer may include an inorganic material that receives light and generates electrical energy. The inorganic material may include, but is not limited to, for example, silicon, single crystal silicon, polycrystalline silicon, amorphous silicon, InGaSe, CuSe, InSe, InGaP, GaAs, a chalcopyrite compound, a perovskite compound, or a kesterite compound.

The InGaSe layer may include one of or a mixture of multiple of In, In₄Se₃, InSe, In₂Se₃, GaSe, Ga2Se₃, and Se; the CuSe layer may include one of or a mixture of multiple of Cu, Cu₂Se, CuSe₂, and Se; and the InSe layer may include one of or a mixture of multiple of In, In₄Se₃, InSe, In₂Se₃, and Se.

The chalcopyrite compound may include at least one selected from, for example, CuAlS₂, CuAlSe₂, CuAlTe₂, CuGaS₂, CuGaSe₂, CuGaTe₂, CuInS₂, CuInSe₂, CuInTe₂, AgAlS₂, AgAlSe₂, AgAlTe₂, AgGaS₂, AgGaSe₂, AgGaTe₂, AgInS₂, AgInSe₂, AgInTe₂, and combinations thereof.

The perovskite compound may include at least one selected from, for example, SrTiO₃, CaTiO₃, and combinations thereof.

Examples of the kesterite compounds may include group I₂-II-IV-VI₄ kesterite compound, and specifically, at least one selected from Cu₂ZnSnS₄, Cu₂ZnSnSe₄, Cu₂ZnGeS₄, Cu₂ZnGeSe₄, Cu₂MnSnS₄, Cu₂MnSnSe₄, Cu₂MnGeS₄, Cu₂MnGeSe₄, Ag₂ZnSnS₄, Ag₂ZnSnSe₄, Ag₂ZnGeS₄, Ag₂ZnGeSe₄, Ag₂MnSnS₄, Ag₂MnSnSe₄, Ag₂MnGeS₄, Ag₂MnGeSe₄, and combinations thereof.

In one example, the energy conversion layer 130 may include organics used for an organic layer generating electrical energy by receiving light in a solar cell field. For example, the energy conversion layer 130 may include thiophene-based compounds. Meanwhile, the energy conversion layer 130 may be an organic-inorganic hybrid type formed by appropriately mixing the inorganic and organic materials described above.

Examples of the organic material may include a fullerene (C₆₀) compound, a phenanthroline derivative such as 2.9-dimethyl-4,7-diphenyl-1,10-phenanthroline (BCP), a phenylpyridine derivative such as 4,6-bis(3,5-di-4-pyridinyl phenyl)-2-methylpyrimidine (B4PymPm) or tris (2,4,6-trimethyl-3-(pyridin-3-yl)phenyl) borane (3TPYMB), a thiophene derivative such as poly(3-hexylthiophene-2,5-diyl) (P3HT), a phthalocyanine derivative, a porphyrin derivative, a triarylamine derivative, a carbazole derivative, or an oligothiophene derivative.

In addition, the organic-inorganic hybrid type may include an organic-inorganic perovskite compound, and examples of the organic-inorganic hybrid type may include a halide-based organic-inorganic perovskite compound. Specific examples of the organic-inorganic hybrid type may include at least one selected from CH₃NH₃PbI₃, CH₃NH₃PbBr₃, CH₃NH₃PbCl₃, CH₃NH₃SnI₃, CH₃NH₃SnBr₃, CH₃NH₃SnCl₃, CH₃NH₃PbI₍₃₋ₓ₎Clₓ, CH₃NH₃PbI₍₃₋ₓ₎Brₓ, CH₃NH₃PbBr₍₃₋ₓ₎Clₓ, CH₃NH₃Pb_{(1-y)}Sn_{y}I₃, CH₃NH₃Pb_{(1-y)}Sn_{y}Br₃, CH₃NH₃Pb_{(1-y)}Sn_{y}Cl₃, CH₃NH₃Pb_{(1-y)}Sn_{y}I₍₃₋ₓ₎Clₓ, CH₃NH₃Pb_{(1-y)}Sn_{y}I₍₃₋ₓ₎Brₓ and CH₃NH₃Pb_{(1-y)}Sn_{y}Br₍₃₋ₓ₎Clₓ (in which 0≤x≤3 and 0≤y≤1), and may include using CFH₂NH₃, CF₂HNH₃, CF₃NH₃, or NH₂CH═NH₂ instead of CH₃NH₃ in the compound.

Alternatively, in one example, the energy conversion layer 130 may include a scintillator that absorbs the radiation energy emitted from the radioactive source 120 and converts the radiation energy into light energy or electrical energy. In addition, at least one surface of the energy conversion layer 130 may include a thin film layer including a scintillator.

In one example, the scintillator may include, but is not limited to, an inorganic compound, such as NaI(Tl), CsI(Tl), GoS, CsI(Na), CsI(pure), CsF, KI(Tl), LiI(Eu), BGO, BaF₂, CaF₂(Eu), ZnS(Ag), CaWO₄, CdWO₄, YAG(Ce) (Y₃Al₅O₁₂(Ce)), GSO, LSO, GAGG:Ce, ZnO(Ga), LaCl₃(Ce), or LaBr₃(Ce); an organic compound, such as anthracene, stilbene, naphthalene, or polyethylene naphthalate; or a combination thereof.

In one example, the energy conversion layer 130 may include a first energy conversion layer 131 that includes a type-I semiconductor adjacent to the first electrode 111 and a second energy conversion layer 132 including a type-II semiconductor adjacent to the second electrode 112.

In one example, one of the type-I semiconductor and the type-II semiconductor may be a P-type semiconductor and the other may be an N-type semiconductor. That is, the type-I semiconductor and the type-II semiconductor may be different types. For example, when the type-I semiconductor is a P-type semiconductor, the type-II semiconductor may be an N-type semiconductor, and when the type-I semiconductor is an N-type semiconductor, the type-II semiconductor may be a P-type semiconductor.

In one example, a P-N junction layer (or intrinsic semiconductor layer) (not illustrated) formed at an interface where the P-type semiconductor and the N-type semiconductor come into contact with each other at an interface between the type-I semiconductor and the type-II semiconductor may be additionally included. The P-N junction layer may be included at the interface between the first energy conversion layer 131 and the second energy conversion layer 132. Electron-hole pairs may be formed in the P-N junction layer. In particular, as the surface area of the interface of the P-N junction layer increases, the amount of electron-hole pairs formed per unit time increases, so there is an effect of improving the efficiency of the radioisotope battery.

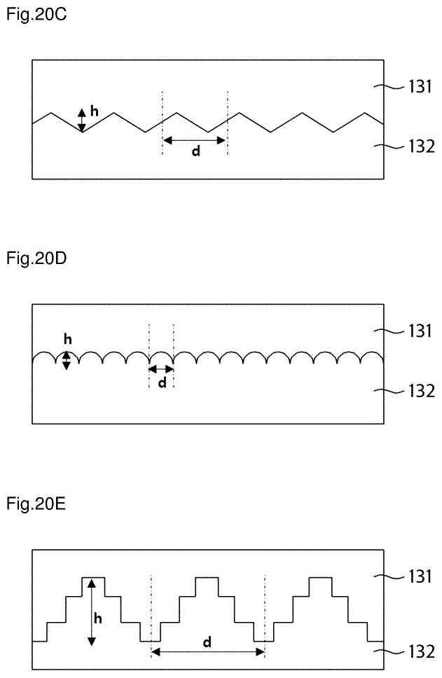

In the electrode assembly 10 according to an example aspect of the present disclosure, in order to increase a surface area of an interface in which the first energy conversion layer 131 and the second energy conversion layer 132 come into contact with each other, the interface may define a planar shape, such as illustrated in FIG. 20A. Other examples may be a concave-convex box or block-like shape (FIG. 20B), a concave-convex triangular shape (FIG. 20C), a wave shape (FIG. 20D), a sinusoidal shape (not shown), or a stepped triangular shape (FIG. 20E). However, these are only examples and are not particularly limited as long as they expand the surface area of the interface. In some examples, the interface described above may be implemented by a method of forming a microstructure, such as by a printing method using CLICHE, or a lithography method, or a wet or dry etching method.

In one example, even if the interface of the energy conversion layer is a generally flat plane, unevenness may be formed to improve the surface area. Such unevenness may include a generally undulating profile having deviations in height away from the generally flat plane of the interface. For example, the interface between the first energy conversion layer 131 and the second energy conversion layer 132 may have an undulating profile defining a concave-convex box or block-like shape, a concave-convex triangular shape, a wave shape, a sinusoidal shape, or a stepped triangular shape, the distance between the low point and the high point of the unevenness of the interface in the stacking dimension of the first energy conversion layer 131 and the second energy conversion layer 132 (which corresponds to the radial dimension of the electrode assembly when rolled up into a jelly roll configuration) may be referred to as a height h. Such height h of the unevenness may be 1% to 90% of the thickness of the first energy conversion layer 131 or the second energy conversion layer 132, and, more specifically, may be 1% to 80%, 1% to 70%, 5% to 60%, or 10% to 50% of such thickness, but is not limited thereto.

When the interface between the first energy conversion layer 131 and the second energy conversion layer 132 has the above-described unevenness or undulations, the width d of the unevenness pattern of the interface in the dimension(s) perpendicular to the height h of the unevenness (which may correspond to either or both of: the axial dimension or the circumferential dimension of the electrode assembly when rolled up into a jelly roll configuration) may be 1/10⁶% to 30% of the total width of the first energy conversion layer 131 or the second energy conversion layer 132 along that dimension (e.g., the total width of the energy conversion layer along the axial dimension). More specifically, the width d of the unevenness pattern may be 1/10⁵% to 20%, 1/10³% to 20%, or 0.01% to 10% of the total width, but is not limited thereto.

In addition, the ratio (B/A×100) of the area A of a planar cross-section defined along the interface between where the first energy conversion layer 131 and the second energy conversion layer 132 (when cut as a plane perpendicular to the stacking dimension without the applied unevenness discussed above) compared to the surface area B defined by the unevenness at the interface may be 110% to 400%. More specifically, the ratio may be 110% to 300%, 120% to 300%, and preferably 120% to 250%. By increasing the surface area of the interface, that ratio (B/A) increases, which is expected to lead to an increase in the amount of electron-hole pairs formed when radiation reaches the surface, thereby improving the efficiency of the battery.

In this specification, examples of the P-type semiconductor may be silicon or diamond doped with boron (B), aluminum (Al), gallium (Ga), or indium (In) that are group 13 elements of the periodic table, or may be a compound semiconductor doped with boron (B), aluminum (Al), gallium (Ga), or indium (In) that are group 13 elements of the periodic table.

In this specification, examples of the N-type semiconductor may be silicon or diamond doped with nitrogen (N), phosphorus (P), arsenic (As), or antimony (Sb) that are group 15 elements of the periodic table, or may be a compound semiconductor doped with nitrogen (N), phosphorus (P), arsenic (As), or antimony (Sb) that are group 15 elements of the periodic table.

In this specification, a compound semiconductor refers to a semiconductor composed of two or more elements, and, for example, may include silicon carbide (SIC), silicon oxide (SiO₂), aluminum phosphide (AIP), aluminum arsenide (AlAs), gallium arsenide (GaAs), gallium nitride (GaN), or the like.

When the first energy conversion layer 131 and the second energy conversion layer 132 form a homogeneous bond, a metal oxide having the chemical formula of AMO₃ (wherein A is at least one selected from the group consisting of La, Ba, Sr, and K, and M is at least one selected from the group consisting of Al, In, Ga, Ti, Sn, Hf, Ta, and Zr) may be used as the first energy conversion layer 131 and the second energy conversion layer 132. Examples of the metal oxide may include at least one selected from the group consisting of BaSnO₃, BaHfO₃, BaZrO₃, BaHf₁₋ₓTiₓO₃ (wherein, 0<x<1), Ba₁₋ₓLaₓSnO₃ (wherein, 0<x<1), Bi₄Ge₃O₁₂, Al₂O₃, Y₂O₃, La₂O₃, Ga₂O₃, Bi₂O₃, ZrO₂, HfO₂, Ta₂O₅, TiO₂, LaInO₃, LaGaO₃, SrZrO₃, SrHfO₃, SrTaO₇, LaIn₁₋ₓGaₓO₃ (wherein, 0<x<1), LaGaO₃, SrTiO₃, KTaO₃, HfSiO₄, Ta₃Ti₂Oₓ (wherein, 0<x<1), and LaAlO₃.

The electrode assembly 10 according to an example aspect of the present disclosure may include a radioactive source 120.

In one example, the radioactive source 120 is a concept including a radiation source or a radioactive source, and the radioactive source may include a radioactive nuclide that emits radiation including at least one selected from, for example, gamma particles (gamma rays), alpha particles (alpha rays), beta particles (beta rays), and neutron radiation (neutron rays).

The radioactive source may include a radioisotope. In one example, the radioactive source 120 may include a radioisotope that emits alpha particles (alpha rays), a radioisotope that emits beta particles (beta rays), or a combination of the two.

In one example, the radioactive source 120 may include a radioisotope that emits alpha particles (alpha rays), examples of which may include at least one selected from the group consisting of americium-241 (²⁴¹Am), americium-243 (²⁴³Am), polonium-209 (²⁰⁹Po), polonium-210 (²¹⁰Po), plutonium-238 (²³⁸Pu), plutonium-239 (²³⁹Pu), curium-242 (²⁴²Cm), curium-244 (²⁴⁴Cm), curium-249 (²⁴⁹Cm), promethium-147 (¹⁴⁷Pm), uranium-238 (²³⁸U), thorium-232 (²³²Th), radium-226 (²²⁶Ra), bismuth-210 (²¹⁰Bi), neptunium-237 (²³⁷Np), europium-152 (¹⁵²Eu), francium-223 (²²³Fr), astatine-210 (²¹⁰At), protactinium-231 (²³¹Pa), einsteinium-253 (²⁵³Es), californium-252 (²⁵²Cf), and berkelium-249 (²⁴⁹Bk), but is not limited thereto.

In one example, the radioactive source 120 may include a radioisotope that emits beta particles (beta rays), examples of which may include at least one selected from the group consisting of tritium (³H), calcium-45 (⁴⁵Ca), nickel (⁶³Ni), copper (⁶⁷Cu), strontium (strontium)-90 (⁹⁰Sr), promethium (promethium)-147 (¹⁴⁷Pm), osmium (osmium)-194 (¹⁹⁴OS), thulium (thulium)-171 (¹⁷¹Tm), tantalum (tantalum)-179 (¹⁷⁹Ta), cadmium (cadmium)-109 (¹⁰⁹Cd), germanium (germanium)-68 (⁶⁸Ge), cerium-159 (¹⁵⁹Ce), and tungsten-181 (¹⁸¹W), but is not limited thereto.

The electrode assembly 10 according to an example aspect of the present disclosure includes at least one groove 113 or 114 on a surface of at least one of the first electrode 111 and the second electrode 112 that faces the energy conversion layer 130, and the radioactive source 120 may be provided in such groove(s) 113 and 114. Such surfaces of the first and second electrodes that face the energy conversion layer 130 may be referred to as inner surfaces of the respective electrodes.

The method of forming a groove in the first electrode and the second electrode may use, for example, a wet etching method, a dry etching method, a roll-to-roll method, or a photoresist method, but is not limited thereto.

FIG. 4 is a cross-sectional view of the first electrode 111 according to an example aspect, and FIG. 5 is a cross-sectional view of the second electrode 112 according to an example aspect.

As illustrated in FIG. 4, the first electrode 111 may include the groove 113 on the surface facing the energy conversion layer 130, and the radioactive source 120 may be provided in the groove 113.

As illustrated in FIG. 5, the second electrode 112 may include the groove 114 on the surface facing the energy conversion layer 130, and the radioactive source 120 may be provided in the groove 114.

In this case, the shapes and depths of the grooves 113 and 114 are not limited as long as they may arrange (or embed) the radioactive source 120 on one surface of the respective first electrode 111 and second electrode 112. The groove 113 of the first electrode 111 and the groove 114 of the second electrode 112 may have the same shape or the shapes may be different from each other.

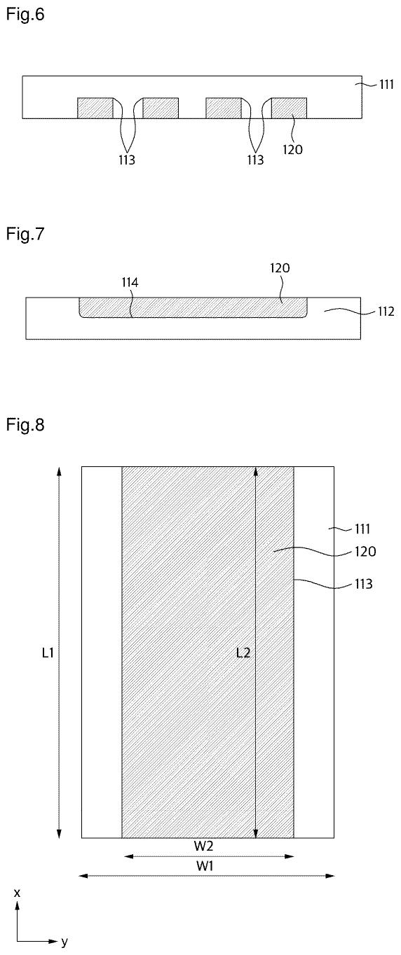

As illustrated in FIG. 6, the groove 113 may be formed by forming a plurality of grooves spaced apart from each other on one surface (e.g., the inner surface facing the energy conversion layer 130) of the electrode (e.g., the first electrode 111). As shown, the grooves 113 are spaced apart such that at least a portion of the inner surface of the electrode 111 free of grooves is defined between adjacent grooves 113. As illustrated in FIG. 7, the groove(s) 114 may include a rounded shape, such as by having rounded corners at the corners of the groove positioned within the electrode (e.g., the second electrode 112).

FIGS. 8 to 12 illustrate plan views of different examples of the first electrode 111 according to aspects of the disclosure.

As illustrated in FIG. 8, in an example aspect, the groove 113 may be formed on one surface of the first electrode 111 and the radioactive source 120 may be arranged inside the groove 113.

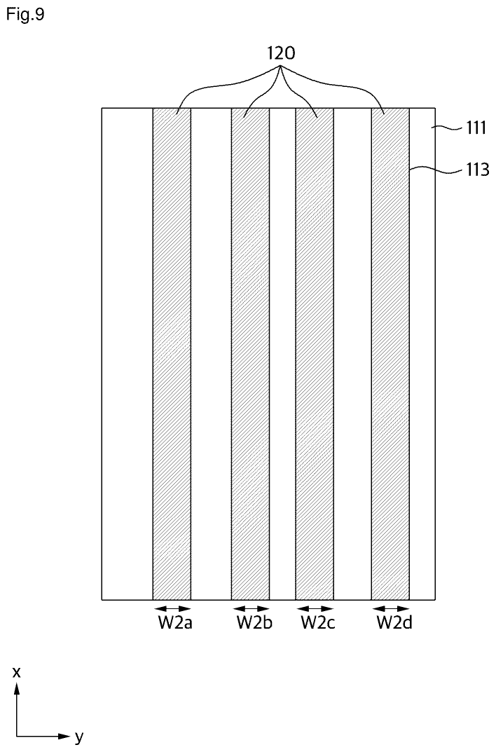

As illustrated in FIG. 9, in an example aspect, the plurality of grooves 113 may be formed on one surface of the first electrode 111 that extend along one dimension (e.g., the x-axis dimension) but are spaced apart in a dimension (e.g., the y-axis dimension) orthogonal to the extension dimension and are formed parallel to each other, and the radioactive source 120 may be arranged inside the groove 113. Alternatively, although not illustrated in the drawing, the plurality of grooves 113 may be formed that extend along the y-axis dimension from one surface of the first electrode 111 but are spaced apart in the x-axis dimension orthogonal to the extension dimension and are formed parallel to each other.

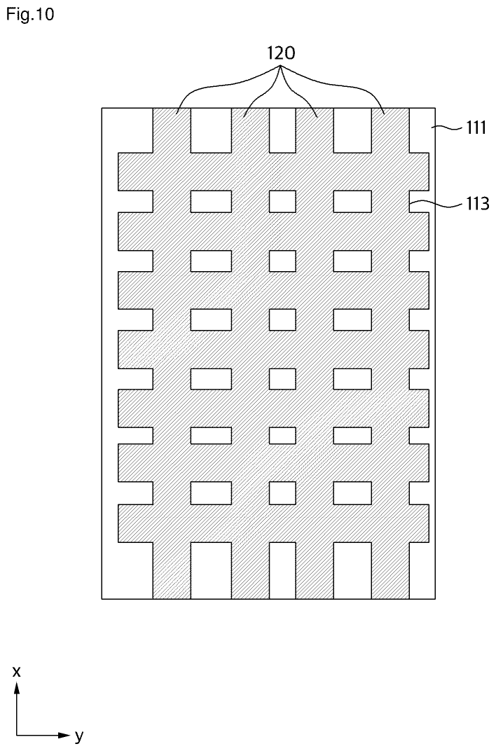

As illustrated in FIG. 10, in an example aspect, a grid-shaped or mesh-shaped groove or grooves 113 may be formed on one surface of the first electrode 111, and the radioactive source 120 may be arranged inside the groove(s) 113.

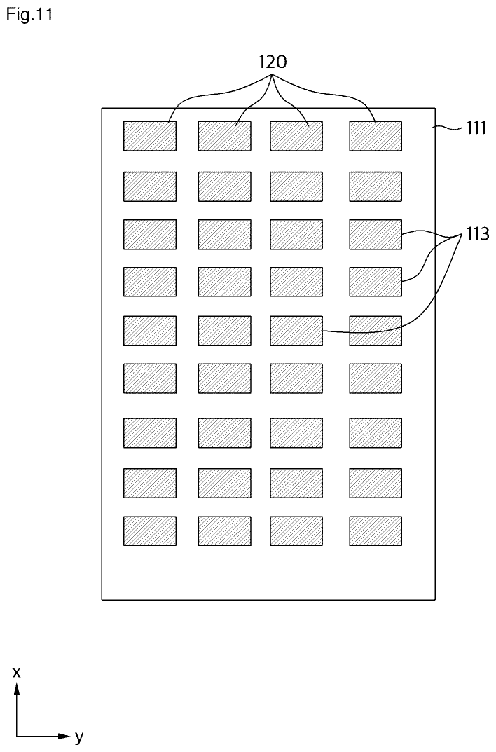

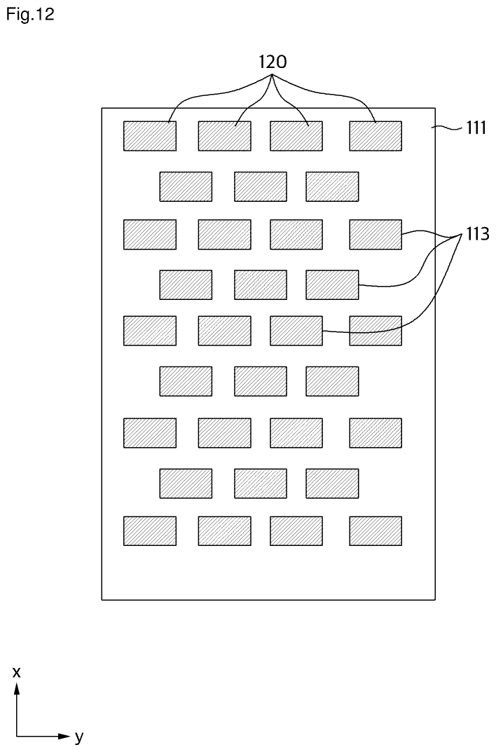

As illustrated in FIG. 11, in an example aspect, the plurality of grooves 113 may be formed in regular rows and columns spaced apart from each other in the x-axis dimension and the y-axis dimension on one surface of the first electrode 111. As illustrated in FIG. 12, in an example aspect, the plurality of grooves 113 may be formed alternately (e.g., in a zigzag pattern/arrangement) or staggered with respect to each other along one of the x-axis dimension or the y-axis dimension on one surface of the first electrode 111.

Referring to FIG. 4, a height H2 of the grooves 113 and 114 may be 1% to 95% of a height H1 of the first electrode 111 in the thickness dimension of the first electrode 111 (which corresponds to the radial dimension of the electrode assembly when rolled up into a jelly roll configuration). Specifically, the height H2 may be 1% to 90%, 1% to 85%, 1% to 80%, 1% to 70%, 2% to 60%, or 5% to 50% of the height H1, but is not limited thereto. A width W2 of the grooves 113 and 114 may be 5% to 100% of a width W1 of the first electrode 111 (which may be parallel to the axial dimension of the electrode assembly when rolled up into a jelly roll configuration). Specifically, the width W2 may be 10% to 100%, 15% to 95%, 20% to 90%, 30% to 90%, 40% to 90%, or 50% to 90% of the width W1, but is not limited thereto.

Referring to FIG. 8, a length L2 of the grooves 113 and 114 may be 5% to 100% of a length L1 of the first electrode 111 (which may be along the circumferential direction of the electrode assembly when rolled up into a jelly roll configuration). Specifically, the length L2 may be 10% to 100%, 15% to 95%, 20% to 90%, 30% to 90%, 40% to 90%, or 50% to 90% of the length L1, but is not limited thereto.

The width W2 and length L2 of the grooves 113 and 114 may mean the sum of widths W2a, W2b, W2c, and W2d of the individual grooves or the sum of lengths of the individual grooves when the plurality of grooves are formed as in FIG. 9.

In an example aspect of the disclosure, the width W2 of the grooves 113 and 114 may be smaller than the width W1 of the first electrode 111 and the second electrode 112. In the case where the terminal ends of the first electrode 111 and the second electrode 112 in the y-axis dimension do not have grooves 113 and 114 formed therealong, the radiation emitted from the radioactive source 120 positioned within the grooves may be prevented from being exiting the assembly above and/or below the jellyroll-shaped electrode assembly 10 along the axial dimension.

FIGS. 8 to 12 illustrate the first electrode 111 as an example, but the same may be applied to the second electrode 112.

The electrode assembly 10 according to one aspect of the present disclosure may have the radioactive source 120 on the inner surface facing the energy conversion layer 130 of at least one of the first electrode 111 and the second electrode 112.

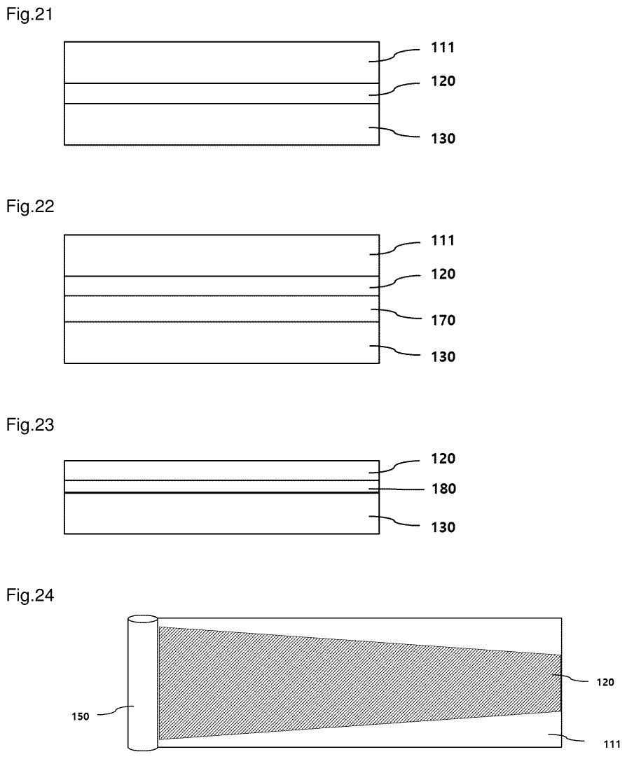

FIG. 21 is a cross-sectional view of the first electrode 111, the radioactive source 120, and the energy conversion layer 130 according to one aspect of the disclosure.

As illustrated in FIG. 21, the first electrode 111 may have the radioactive source 120 on the inner surface facing the energy conversion layer 130.

Although not illustrated in the drawing, the second electrode 112 may have the radioactive source 120 on the surface facing the energy conversion layer 130.

In addition, the electrode assembly 10 according to one aspect of the present disclosure may be provided with the radioactive source 120 on the energy conversion layer 130. In one case, forming the radioactive source 120 along the side of the energy conversion layer 130 that includes the N-type semiconductor may increase the interaction between the radiation source 120 and the energy conversion layer 130 (i.e., the absorption by the energy conversion layer 130 of the radiation emitted by the radiation source 120), which is advantageous in terms of efficiency. However, in alternative examples, the radioactive source 120 may be formed along the side of the energy conversion layer 130 that includes the P-type semiconductor.

In some aspects, the surface area of an interface between the radioactive source 120 and the energy conversion layer 130 (e.g., the side of the energy conversion layer 130 including the N-type semiconductor) may be increased by any of the techniques to produce unevenness so as to result in any of the interface profiles discussed above in connection with the interface between the first energy conversion layer 131 and the second energy conversion layer 132. For example, any one of the generally undulating profiles discussed in connection with FIGS. 20A-E may be provided at the interface between the radioactive source 120 and the energy conversion layer 130.

In the electrode assembly 10 according to one aspect of the present disclosure, the method of forming the radioactive source 120 may include, but is not limited to, electroplating, electroless plating, or chemical vapor deposition (CVD). Particularly considering radiation shielding and safety of workers, an electroplating method may be preferred, as it is a relatively simple process and it is generally easy to control the reaction.

In one example, a plating solution for the electroplating may be prepared, and when Ni-63 is used as the radioactive source 120, for example, Ni-62 may be irradiated with neutrons to produce Ni-63, and then chlorinated to produce ⁶³NiCl₂, thereby producing a Ni-63 electrolyte. Alternatively, Ni-62 may be chlorinated first to produce ⁶²NiCl₂, and then irradiated with neutrons to produce ⁶³NiCl₂, but this is only an example and is not limited thereto.

In one example, the plating solution may further include additives such as a pH regulator or a pH stabilizer, in which case there may be an advantage in that the speed or growth rate of plating may be controlled, thereby making the formation of the radioactive source 120 uniform or easy.

In one example, when forming the radioactive source 120, the energy conversion layer 130 may additionally include a seed layer or a catalyst particle layer 180, as illustrated in FIG. 23. The seed layer or catalyst particle layer 180 may be formed in advance to allow the energy conversion layer 130 to be filled with the radioactive source 120, and the seed layer or catalyst particle layer 180 may be configured to include, for example, a metal such as Ni, Pd, Pt, or Au. In this case, the seed layer or catalyst particle layer 180 may be formed by a deposition or plating method, but is not limited thereto.

In one example, when the radioactive source is formed in the first electrode or the second electrode, or in the energy conversion layer, the concentration (or content) of the radioisotope in any region close to the central member at the central axis may be higher than the concentration (or content) of the radioisotope in any region far from the central member. For example, the radioisotope concentration (or content) of the radioactive source may be formed to have a gradient in which the concentration (or content) decreases as the region moves away from the central member. In this case, since the radioactive source is concentrated toward the center member, the radiation shielding effect may be improved after the electrode assembly is wound.

In one example, as illustrated in FIG. 24, when the radioactive source 120 is formed on the first electrode 111 or the second electrode 112, or on the energy conversion layer 130, if the thickness formed is the same, the area where the radioactive source 120 is formed may be configured such that the area decreases as it moves away from the center member 150. The shape for decreasing the area of the radioactive source 120 at greater radial distances from the central axis is not limited to that shown in FIG. 24, however, and other shapes or techniques may be utilized for decreasing the area and/or amount of the radioactive source 120 at increasing radial distances. Furthermore, the above-described examples of unevenness for increasing the surface area may be utilized in conjunction with shapes or techniques for decreasing the area and/or amount of the radioactive source 120 at larger radial distances like that illustrated in FIG. 24.

In one example, a third electrode 170 may be further provided between the energy conversion layer 130 and the radioactive source 120.

FIG. 22 is a cross-sectional view of the first electrode 111, the radioactive source 120, the third electrode 170, and the energy conversion layer 130 according to one aspect of the disclosure.

As illustrated in FIG. 22, the third electrode 170 may be provided between the energy conversion layer 130 and the radioactive source 120.

In other aspects (not shown), the third electrode 170 may be equally utilized in conjunction with the second electrode 112 described above. That is, where the electrode equipped with the radioactive source 120 is the first electrode 111 and where the third electrode 170 is provided between the radioactive source 120 and the energy conversion layer 130, the third electrode 170 may include the same material as the first electrode 111. Alternatively, where the electrode equipped with the radioactive source 120 is the second electrode 112 and where a third electrode 170 is provided between the radioactive source 120 and the energy conversion layer 130, the third electrode 170 may include the same material as the second electrode 112.

However, the third electrode 170 does not necessarily have to be the same material as the first electrode 111 and/or the second electrode 112, but rather may include different materials.

The third electrode 170 may have a thickness of 90% or less of the thickness of the first electrode 111 or the second electrode 112. In addition, the third electrode 170 may have a very thin film shape. For example, the thickness of the third electrode 170 may be 1% to 90%, 5% to 80%, 10% to 70%, 15% to 60%, or 20% to 50% of the thickness of the first electrode 111 or the second electrode 112. Since the third electrode 170 is thinner than the first electrode 111 and the second electrode 112, it may efficiently allow radiation emitted from the radioactive source 120 to reach the energy conversion layer 130.

In the case where the third electrode 170 is provided between the radioactive source 120 and the energy conversion layer 130, the first electrode 111 or the second electrode 112 may be arranged on an opposite side of the radioactive source 120 from the third electrode 170, in which case the third electrode 170 may act as a radiation shield. Furthermore, when the electrode assembly is wound, the shielding function of the third electrode 170 may be further maximized.

In the electrode assembly 10 according to an example aspect of the present disclosure, the radiation (e.g., alpha rays or beta rays) generated from the radioactive source 120 may be incident on as large an amount of the energy conversion layer 130 as possible, which may be advantageous for high output.

In one example, the energy conversion layer 130 may be in contact with the radioactive source 120 and may form an interface. Specifically, the energy conversion layer 130 may be in direct contact with the type-I semiconductor or the type-II semiconductor of the energy conversion layer 130, so as to form an interface.

The efficiency of the radioisotope battery may increase when the surface area of the interface between the energy conversion layer 130 and the radioactive source 120 increases, and therefore significant benefits may result from improving the interface characteristics between the radioactive source 120 and the energy conversion layer 130, particularly where the radioactive source 120 is formed along and in contact with the N-type semiconductor.

In one example, the first electrode 111 may be in contact with at least a portion of the first energy conversion layer 131. In an example aspect, the second electrode 112 may be in contact with at least a portion of the second energy conversion layer 132.

In the energy conversion layer 130, electron-hole pairs are formed from radiation from the radioactive source 120, and a current is generated from the electron-hole pairs to produce electrical energy. In this case, a portion of the first electrode 111 and the second electrode 112 may be electrically connected by contacting a portion of the energy conversion layer 130 to accommodate the electron-hole pairs generated in the energy conversion layer 130.

In one example, the first electrode 111 and the second electrode 112 may not be in contact with each other. Since a short circuit may occur when the first electrode 111 and the second electrode 112 come into contact with each other, which may cause a problem, the electrode assembly 10 includes the energy conversion layer 130 between the first electrode 111 and the second electrode 112, and the energy conversion layer 130 may serve to physically and/or electrically separate the first electrode 111 and the second electrode 112.

In one example, the energy conversion layer 130 may have an area equal to or larger than that of the first electrode 111 and the second electrode 112, and when the first electrode 111, the second electrode 112, and the energy conversion layer 130 are stacked, the energy conversion layer 130 may be included in the space between the surfaces of the first electrode 111 and the second electrode 112 facing each other.

The electrode assembly 10 according to an example aspect of the present disclosure may include an insulating layer 160 along the outer surface of at least one of the first electrode 111 and the second electrode 112 opposite to the inner surface facing the radioactive source 120. As a result, by including the insulating layer 160 in that location, it may possible to prevent the first electrode 111 from coming into contact with the second electrode 112 when wound into a jelly roll configuration, which would cause an electrical problem such as a short circuit.

The insulating layer 160 may be included along a side of the first electrode 111, a side of the second electrode 112, or along both of the first electrode 111 and the second electrode 112. In one example, the insulating layer 160 may be positioned along a side of the first electrode 111 in order to prevent the central member 150 and the first electrode 111 from directly contacting each other, but the present disclosure is not limited thereto.

In one example, the insulating layer 160 is not specifically limited as long as it is made of a material with an electrical insulation property, but may include one or more selected from a group consisting of, for example, a silicate (e.g., TEOS), silicon nitride (SiN), hafnium oxide, hafnium silicon oxide, hafnium aluminum oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, and aluminum oxide.

In one example, the insulating layer 160 may include a dielectric. The dielectric is not particularly limited as long as it is used in the art. The dielectric layer may optimize the arrangement of the radioactive source 120 and may minimize the occurrence of leakage current, thereby further improving electrical stability.

In one example, the dielectric included in the insulating layer 160 may include a low-k dielectric having a dielectric constant of less than 3.9. The low-k dielectric is not specifically limited as long as it is used in the field, but may include one or more selected from the group consisting of Fluorinated TetraEthylOrthoSilicate (FTEOS), Hydrogen SilsesQuioxane (HSQ), Bis-benzoCycloButene (BCB), TetraMethylOrthoSilicate (TMOS), OctaMethyleyCloTetraSiloxane (OMCTS), HexaMethylDiSiloxane (HMDS), TriMethylSilyl Borate (TMSB), DiAcetoxyDitertiaryButoSiloxane (DADBS), TriMethylSilil Phosphate (TMSP), Poly TetraFluoroEthylene (PTFE), Tonen SilaZen (TOSZ), Fluoride Silicate Glass (FSG), polyimide nanofoams such as polypropylene oxide, Carbon Doped silicon Oxide (CDO), Organo Silicate Glass (OSG), SiLK™ (Dow Chemical), Amorphous Fluorinated Carbon, silica aerogels, silica xerogels, and mesoporous silica. When the dielectric of the insulating layer 160 includes a low-k dielectric, the generation of leakage current may be minimized while, for example, the radiation generated from the radioactive source 120 may be efficiently transmitted to the energy conversion layer 130.

In one example, the dielectric included in the insulating layer 160 may include a high dielectric constant of 3.9 or greater. The high-k dielectric is not particularly limited as long as it is used in the art, but examples of such high-k dielectric may include one or more selected from the group consisting of boron nitride, hafnium oxide, hafnium silicon oxide, hafnium aluminum oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate, but is not limited thereto. When the dielectric disposed on the insulating layer 160 includes a high-k dielectric, the radioisotope battery may have a high degree of integration while minimizing the occurrence of leakage current.

FIG. 2 is a perspective, partially exploded view illustrating the electrode assembly 10 according to another aspect of the present disclosure. In one example, as illustrated in FIG. 2, the electrode assembly 10 may be a jelly roll type electrode assembly wound around a central member 150 in one direction while the first electrode 111, the second electrode 112, the energy conversion layer 130 provided between the first electrode 111 and the second electrode 112, and the radioactive source 120 provided in the space between the second electrode 112 and the energy conversion layer 130, are stacked, and may include the insulating layer 160 along the outer surface of the first electrode facing away from the radioactive source 120.

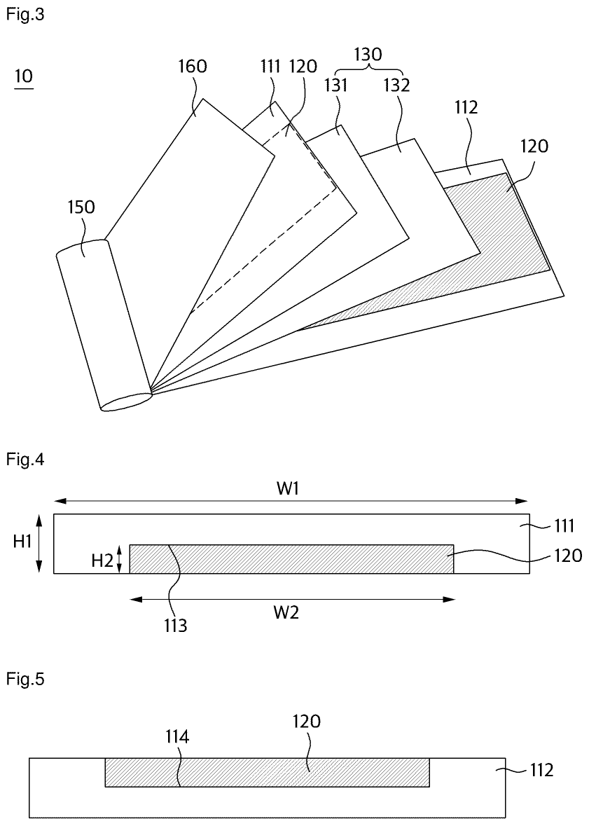

FIG. 3 is a perspective, partially exploded view illustrating the electrode assembly 10 according to another aspect of the present disclosure. In one example, as illustrated in FIG. 3, the electrode assembly 10 is a jelly roll type electrode assembly wound around a central member 150 in one direction while a first electrode 111, a second electrode 112, an energy conversion layer 130 provided between the first electrode 111 and the second electrode 112, and a radioactive source 120 are stacked. The radioactive source 120 may be provided as two layers, one of which may be positioned in a space between the first electrode 111 and the energy conversion layer 130, and the other of which may be positioned in a space between the second electrode 112 and the energy conversion layer 130. The electrode assembly 10 may include an insulating layer 160 along the outer surface of at least one of the first electrode 111 and the second electrode 112 facing away from the radioactive source 120. For example, with reference to FIG. 3, an insulating layer 160 may be positioned along the surface of the first electrode 111 opposite to that which includes the radioactive source 120.

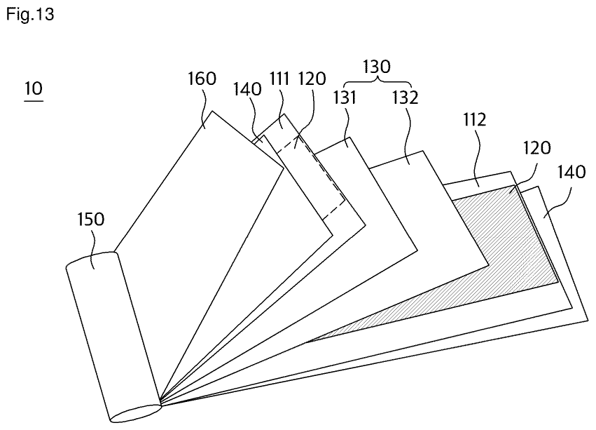

FIG. 13 is a perspective, partially exploded view illustrating an electrode assembly 10 according to an example aspect of the present disclosure.

In one example, the electrode assembly 10 may further include a protective layer 140 along the outer surface of the first electrode 111 and/or the second electrode 112 facing away from the respective radioactive source 120.

In one example, the protective layer 140 may serve to reflect the radiation (e.g., alpha rays or beta rays) emitted from the radioactive source 120 so that it may be focused on the energy conversion layer 130, but it is not limited to any particular material known in the art that may reflect the radiation. In one example, the protective layer 140 may include a material known to have radiation shielding or reflecting properties, such as copper, silver, or aluminum metal, or a polymer such as polyethylene, polypropylene, ethylene propylene copolymer, ethylene methacrylate copolymer, or polyethylene terephthalate, but is not limited thereto.

FIG. 14 is a perspective, partially exploded view illustrating the electrode assembly 10 according to an example aspect of the present disclosure.

In one example, the first electrode 111 and the second electrode 112 included in the electrode assembly 10 may further include a first electrode tab 115 and a second electrode tab 116 on at least a portion of the surface of the respective electrode opposite to the surface facing the energy conversion layer 130.

In one example, different from that illustrated in FIG. 14, a plurality of first electrode tabs 115 may be spaced apart along an edge of the first electrode 111, which may be an edge of the first electrode 111 at one end of the first electrode 111 along the axial dimension of the central member 150, which edge extends circumferentially about the central axis of the central member 150 to define a spiral shape when the electrode assembly 10 is wound into a jelly roll configuration. Likewise, a plurality of second electrode tabs 116 may be spaced apart along an edge of the second electrode 112, which may be an edge of the second electrode 112 at the opposite axial end of the electrode assembly 10 from the edge having the plurality of first electrode tabs 115. The plurality of first electrode tabs 115 and the plurality of second electrode tabs 116 may be spaced apart along the respective edge of the respective first and second electrode 111, 112 at predetermined intervals. Those intervals may be set such that, when the electrode assembly is wound as illustrated in FIG. 16 and formed into the jelly roll configuration, the spacing results in the first electrode tabs 115 overlaping each other at a single circumferential location about the central axis, and the spacing may similarly result in the second electrode tabs 116 overlaping each other at a single circumferential location about the central axis.

FIG. 15 is a perspective view illustrating the electrode assembly 10 according to an example aspect of the present disclosure.

In one example, in the electrode assembly 10, the first electrode 111 includes a first uncoated part 161 that is exposed beyond the energy conversion layer 130 in the axial dimension, and the first uncoated part 161 includes a plurality of first joint parts 117 in the form of tabs integrally formed with the current collector of the first electrode 111 and spaced apart from one another in a circumferential dimension along an axial edge of the first electrode 111. Similarly, the second electrode 112 includes a second uncoated part 162 that is exposed beyond the energy conversion layer 130 in the axial dimension at the opposite axial end of the electrode assembly 10 from the first uncoated part 161, and the second uncoated part 162 includes a plurality of second joint parts 118 also in the form of tabs integrally formed with the current collector of the second electrode 112 and spaced apart from one another in a circumferential dimension along the edge of the second electrode 112 at the axially opposite end of the electrode assembly from first joint parts 117.

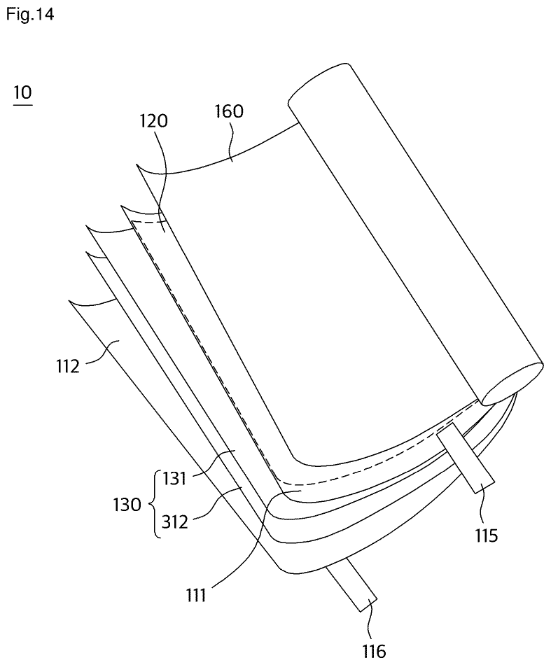

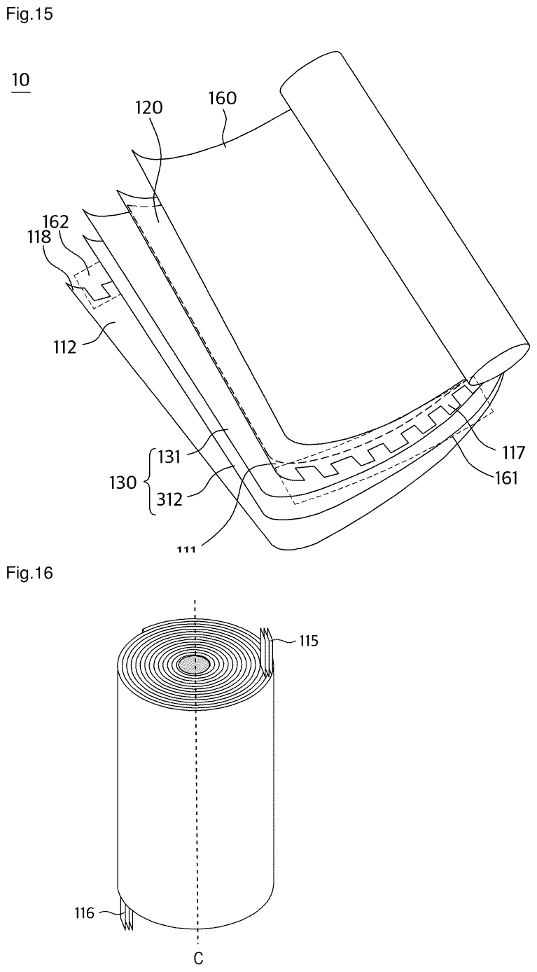

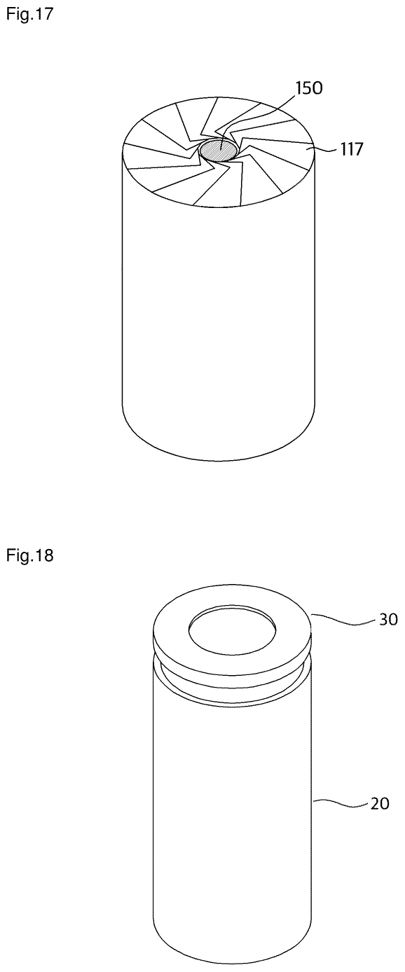

In one example, as illustrated in FIG. 17, the first joint parts 117 and the second joint parts 118 are bendable and may be bent toward the central axis of the central member 150 when the electrode assembly 10 is in the wound configuration.

The electrode assembly 10 according to another example aspect (not shown) may have a tabless structure. That is, unlike the separate tab-like joint parts 117, 118 spaced apart along the respective first and second electrodes 111, 112, the first uncoated part 161 of the first electrode 111 and the second uncoated part 162 of the second electrode 112 may each include an elongated first joint part 117 and an elongated second joint part 118, respectively, which each extend along a substantial length of the respective first and second electrode 111, 112 in the circumferential dimension. Such first joint part 117 and second joint part 118 may each function as a respective tab, thereby not requiring a plurality of individual tabs for each electrode 111, 112.

The shapes of the first joint part 117 and the second joint part 118 (either the spaced apart, tab-like joint parts or the single, elongated joint parts) may have a rectangular shape as illustrated, but the shape is not limited thereto. For example, the first joint part 117 and the second joint part 118 may each have various other shapes such as a square, a trapezoid, a triangle, a parallelogram, a semicircle, and a semi-ellipse.

The electrode assembly 10 according to an example aspect of the present disclosure may include the central member 150, and the central member 150 may serve to provide an optimized curvature in the jelly roll structure when the various layers of the electrode assembly 10, including the insulating layer 160, the first electrode 111, the radioactive source 120, the energy conversion layer 130, and the second electrode 112, are wound.

In one example, the electrode assembly 10 may be a jelly roll type electrode assembly that is wound around the central member 150 in one direction.

In one example, the central member 150 may include a dielectric, and the type of dielectric is not particularly limited as long as it is used in the art. When the central member 150 includes a dielectric, the electrical stability may be further improved by minimizing the occurrence of leakage current.

In one example, the dielectric included in the central member 150 may include a low-k dielectric having a dielectric constant of less than 3.9. The low-k dielectric is not specifically limited as long as it is used in the field, but may include one or more selected from a group consisting of Fluorinated TetraEthylOrthoSilicate (FTEOS), Hydrogen SilsesQuioxane (HSQ), Bis-benzoCycloButene (BCB), TetraMethylOrthoSilicate (TMOS), OctaMethyleyCloTetraSiloxane (OMCTS), HexaMethylDiSiloxane (HMDS), TriMethylSilyl Borate (TMSB), DiAcetoxyDitertiaryButoSiloxane (DADBS), TriMethylSilil Phosphate (TMSP), PolyTetraFluoroEthylene (PTFE), Tonen SilaZen (TOSZ), Fluoride Silicate Glass (FSG), polyimide nanofoams such as polypropylene oxide, Carbon Doped silicon Oxide (CDO), Organo Silicate Glass (OSG), SiLKTM (Dow Chemical), Amorphous Fluorinated Carbon, silica aerogels, silica xerogels, and mesoporous silica. When the dielectric included in the central member 150 includes a low-k dielectric, the generation of leakage current may be minimized while, for example, the radiation generated from the radioactive source 120 may be efficiently transmitted to the energy conversion layer 130.

In one example, the dielectric included in the central member 150 may include a high-k dielectric having a dielectric constant of 3.9 or more. The high-k dielectric is not particularly limited as long as it is used in the art, but examples of such high-k dielectric may include one or more selected from the group consisting of boron nitride, hafnium oxide, hafnium silicon oxide, hafnium aluminum oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate, but is not limited thereto. When the dielectric included in the central member 150 includes a high-k dielectric, the radioisotope battery may have a high degree of integration while minimizing the occurrence of leakage current.

In one example, an aspect ratio of the central member 150 may be 1 to 100. In cases where the central member 150 is cylindrical, the aspect ratio of the central member 150 may refer to a value obtained by dividing the height of the central member 150 (along its central longitudinal axis) by the diameter, resulting in a ratio of the height to the diameter of the central member 150. In one example, in cases where the central member 150 is an elliptical cylinder or a polygonal cylinder, the aspect ratio of the central member 150 may refer to a value obtained by dividing a height of the central member 150 by a major axis or a major side length.

In one example, by adjusting the aspect ratio of the central member 150, the integration of the radioisotope battery including the electrode assembly 10 may be increased to improve the output or improve the energy density.

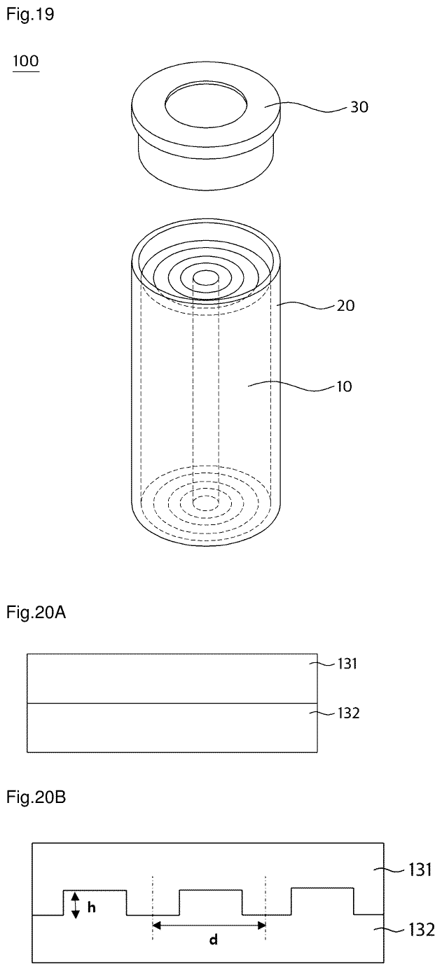

FIGS. 18 and 19 are perspective views illustrating a radioisotope battery 100 according to an example aspect of the present disclosure, where FIG. 19 is partially transparent and partially exploded for illustrative purposes.

The radioisotope battery 100 according to an example aspect of the present disclosure may include the electrode assembly 10 described above; a housing 20 that accommodates the electrode assembly 10; and a cap assembly 30 that is provided to cover an open upper portion of the housing 20.

In one example, the housing 20 may be cylindrical, and the electrode assembly 10 may be accommodated within the housing 20. A diameter of the housing 20 may be at least slightly larger than that of the electrode assembly 10. A separate insulating member and/or shielding member may be further included in the space between the electrode assembly 10 and the housing 20. The insulating member may include one or more of the materials included in the insulating layer, but is not limited thereto. The shielding member may include one or more of the materials included in the protective layer, but is not limited thereto.

In one example, the housing 20 may be a metal or alloy that has radiation shielding properties and is conductive, and may include, for example, a metal including aluminum, steel, stainless steel, or lead, or an alloy thereof, but is not limited thereto.

In one example, the first electrode tab 115 or the first joint part 117 may be welded and electrically connected to a lower, closed end of the housing 20. Alternatively, the second electrode tab 116 or the second joint part 118 may be welded and electrically connected to the lower, closed end of the housing 20. The welding may done by any welding method for electrode tabs and/or leads that is commonly used in secondary batteries, such as, for example, laser welding. The housing 20 may thus be electrically connected to whichever of the first electrode 111 or the second electrode 112 is welded thereto.

In one example, the lower closed portion of the housing 20 may additionally include one or more of a variety of insulating members and/or shielding members, as long as they do not interfere with the electrical connection of the first electrode 111 or the second electrode 112.

In one example, the cap assembly 30 is configured to seal the housing 20 in which the electrode assembly 10 is accommodated. The cap assembly 30 may be a metal or alloy that has radiation shielding properties and is conductive, like the housing 20, and the same metals or alloys identified above in connection with the housing 20 may also be available for the cap assembly 30.

In one example, the cap assembly 30 may be electrically connected to the first electrode 111 or the second electrode 112 by welding the first electrode tab 115 or the first joint part 117 to the cap assembly 30 or by welding the second electrode tab 116 or the second joint part 118 to the cap assembly 30. Thus, when the cap assembly 30 is electrically connected to the first electrode 111, the housing 20 may be electrically connected to the second electrode 112. Conversely, when the cap assembly 30 is electrically connected to the second electrode 112, the housing 20 may be electrically connected to the first electrode 111.

The cap assembly 30 may further include a heat dissipation member or a venting member that discharges heat or gas generated within the housing 20.

The radioisotope battery 100 according to an example aspect of the present disclosure may be utilized in connection with and/or incorporated into electronic products requiring high power by generating high-density energy. Electronic products requiring high power may include a variety of power-consuming products, such as, for example, semiconductor memories (including DRAM or NAND flash), processors, mobile devices, and computers, among others.

The radioisotope battery 100 according to an example aspect of the present disclosure may be a cylindrical radioisotope battery, and may be, for example, an 18650 cell (diameter 18 mm, height 65 mm, form factor ratio 0.277), a 21700 cell (diameter 21 mm, height 70 mm, form factor ratio 0.300), a 46110 cell (diameter 46 mm, height 110 mm, form factor ratio 0.418), a 48750 cell (diameter 48 mm, height 75 mm, form factor ratio 0.640), a 48110 cell (diameter 48 mm, height 110 mm, form factor ratio 0.418), a 48800 cell (diameter 48 mm, height 80 mm, form factor ratio 0.600), a 46800 cell (diameter 46 mm, height 80 mm, form factor ratio 0.575), a 46900 cell (diameter 46 mm, height 90 mm, form factor ratio 0.511), a 46950 cell (diameter 46 mm, height 95 mm, form factor ratio 0.484), a 46100 cell (diameter 46 mm, height 100 mm, form factor ratio 0.460), and a 46120 cell (diameter 46 mm, height 120 mm, form factor ratio 0.383), but is not limited thereto. In this case, the form factor ratio means a value obtained by dividing the diameter of the cylindrical battery by the height.

A battery pack according to an example aspect of the present disclosure may include the radioisotope battery 100. The battery pack may further include a battery module including one or more of the radioisotope batteries 100, or may include a battery pack structure, e.g., in a cell to pack” (CTP) arrangement, that omits the module and includes a plurality of the radioisotope batteries 100 arranged within the pack.

In one example, the battery pack may include a pack housing, and may further include a cell frame that is accommodated in the pack housing. The cell frame may serve to support and accommodate the cylindrical radioisotope batteries 100. The battery pack may further include a top plate on the upper portion of the pack housing, and the battery pack may further include a heat dissipation member capable of dissipating heat generated from the radioisotope battery 100 to the outside.

In one example, the battery pack and/or battery module may be utilized in the same manner and in the same applications as conventional secondary batteries, but may further include a radiation shielding component to prevent external leakage of radiation due to the radioactive isotope used.

While various example aspects of the present disclosure have been illustrated and described above, it will be apparent to those skilled in the art that modifications and variations could be made without departing from the scope of the present disclosure as defined by the appended claims. In addition, the example aspects may be implemented by deleting some features or components from the above-described example aspects. Similarly, additional aspects may be implemented by combining features from any of the above-described aspects with each other.

What is claimed is:

1. An electrode assembly comprising:
a first electrode,
a second electrode,
an energy conversion layer positioned between the first electrode and the second electrode, and
a radioactive source positioned either between the first electrode and the energy conversion layer or between the second electrode and the energy conversion layer,
wherein the first electrode, the second electrode, the energy conversion layer, and the radioactive source are arranged in layers on one another and collectively wound in one direction around a central axis to define a jelly roll configuration.

2. The electrode assembly of claim 1, further comprising an insulating layer positioned along an outer surface of at least one of the first electrode and the second electrode that faces away from the radioactive source.

3. The electrode assembly of claim 2, wherein the insulating layer includes a first insulating layer and a second insulating layer, the first insulating layer positioned along the outer surface of the first electrode, and the second insulating layer positioned along the outer surface of the second electrode.

4. The electrode assembly of claim 1, wherein the radioactive source includes a first radioactive source and a second radioactive source, the first radioactive source positioned between the first electrode and the energy conversion layer, and the second radioactive source positioned between the second electrode and the energy conversion layer.

5. The electrode assembly of claim 1, wherein the radioactive source is positioned along an inner surface of either the first electrode or the second electrode that faces towards the energy conversion layer.

6. The electrode assembly of claim 5, wherein the radioactive source is positioned along the inner surface such that a decreasing amount of the radioactive source is located at increasing distances along the inner surface from the central axis.

7. The electrode assembly of claim 5, wherein the inner surface of either the first electrode or the second electrode includes at least one groove defined within it, the radioactive source being positioned within the at least one groove.

8. The electrode assembly of claim 7, wherein the at least one groove includes a plurality of grooves spaced apart from each other such that at least a portion of the inner surface without any grooves is located between at least two adjacent ones of the plurality of grooves.

9. The electrode assembly of claim 1, wherein the radioactive source includes a radioisotope that emits alpha particles or beta particles.

10. The electrode assembly of claim 1, further comprising a third electrode positioned between the energy conversion layer and the radioactive source.

11. The electrode assembly of claim 1, wherein the energy conversion layer comprises a first energy conversion layer and a second energy conversion layer, the first energy conversion layer including a first type of semiconductor material adjacent to the first electrode, and the second energy conversion layer including a second type of semiconductor material adjacent to the second electrode.

12. The electrode assembly of claim 11, wherein one of the first and second types of semiconductor materials is a P-type semiconductor and the other of the first and second types of semiconductor materials is an N-type semiconductor, such that a P-N junction is defined at an interface between the P-type semiconductor and the N-type semiconductor.

13. The electrode assembly of claim 11, wherein the first electrode is in contact with at least a portion of the first energy conversion layer, and the second electrode is in contact with at least a portion of the second energy conversion layer.

14. The electrode assembly of claim 11, wherein the radioactive source is in contact with the first energy conversion layer at an interface having an undulating profile.

15. The electrode assembly of claim 1, wherein the first electrode and the second electrode further comprise a first electrode tab and a second electrode tab, respectively, on at least a portion of an outer surface of the respective first and second electrode that faces away from the energy conversion layer.

16. The electrode assembly of claim 1, further including a central member oriented along the central axis.

17. The electrode assembly of claim 1, further comprising a protective layer positioned along an outer surface of at least one of the first electrode and the second electrode that faces away from the radioactive source.

18. The electrode assembly of claim 1, wherein the energy conversion layer includes a seed layer or a catalyst particle layer.

19. A radioisotope battery, comprising:
the electrode assembly of claim 1;
a housing accommodating the electrode assembly therein; and
a cap assembly positioned to cover an open upper portion of the housing.

20. A battery pack comprising the radioisotope battery of claim 19.
